(19) United States
(12) Patent Application Publication
(10) Pub. No.: US 2009/0009414 A1
(43) Pub. Date: Jan. 8, 2009

(54) ANTENNA ARRAY

(76) Inventor: Arne Reykowski, Gainesville, FL (US)

Correspondence Address: SCHIFF HARDIN, LLP;PATENT DEPARTMENT, 6600 SEARS TOWER, CHICAGO, IL, 60606-6473, US

(21) Appl. No.: 12/137,714

(22) Filed: Jun. 12, 2008

(30) Foreign Application Priority Data
Jun. 12, 2007 (DE) 10 2007 026 965.1

(51) Int. Cl. H01Q 11/12

(52) U.S. Cl. 343/742

(57) ABSTRACT

An antenna array has multiple individual antennas arranged next to one another. The individual antennas are respectively arranged within a radio-frequency, closed conductor loop, with capacitors inserted in each conductor loop.

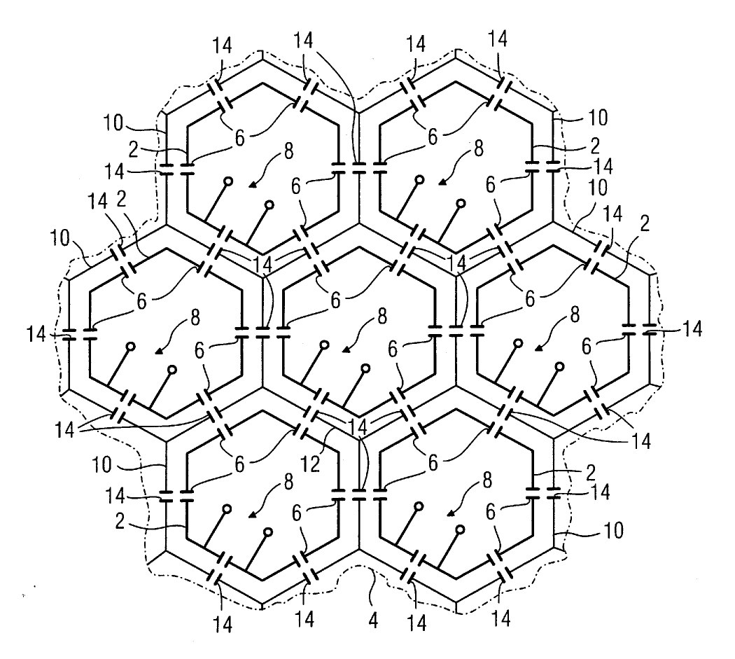

### BACKGROUND OF THE INVENTION

1. Field of the Invention

The present invention concerns an antenna array of the type having multiple individual antennas arranged next to one another and that are respectively within a radio-frequency, closed conductor loop.

2. Description of the Prior Art

In medical imaging by means of magnetic resonance, radio-frequency magnetic fields in the MHz range are received from a human or animal body and processed further for imaging.

Antenna arrays with multiple individual antennas arranged next to one another are used as local antennas or local coils in medical magnetic resonance imaging in order to optimally acquire magnetic resonance signals from only a limited area of a living body to be examined. This results in (S/N ratio) a high signal-noise ratio in the received signal in comparison to acquisition with a whole-body antenna. The individual antennas are generally arranged on a surface that is adapted to the anatomy of the examination area.

In antenna arrays with multiple individual antennas arranged next to one another, a radio-frequency current in one of the individual antennas can generally induce a voltage in adjacent individual antennas, which is known as coupling. Couplings occur both in circularly-polarized antenna arrangements and arrangements of linearly-polarized individual antennas. Couplings degrade the signal-noise ratio. The expenditure for checking the operation of coupled individual antennas is greater than for the checking uncoupled individual antennas. It is therefore desirable to avoid coupling of individual antennas.

An antenna array of the aforementioned type with individual antennas decoupled from one another is described in WO 2005/076029A1. The antenna array has multiple individual antennas arranged next to one another. The conductors of the individual antennas are arranged in the shape of a regular hexagon on a surface. Each individual antenna is surrounded by a closed conductor loop that is likewise executed as a regular hexagon in terms of its shape. This circumferential and closed conductor loop acts as a shielding both from electrical and magnetic fields. For further reduction of remaining, slight couplings of adjacent individual antennas, it is proposed to arrange the surrounding conductor loops such that they at least partially overlap.

A further array with individual antennas decoupled from one another is known from DE 195 13 231 A1. There a superconducting layer that exhibits circular recesses arranged in a matrix is applied over the entire surface on a dielectric substrate. A superconducting circular ring antenna is respectively provided in the circular recesses, likewise on the substrate. The superconducting layer causes a homogenization and/or increase of the field strength of the radio-frequency magnetic field relevant for the application in the imaging volume.

An antenna array with multiple individual antennas arranged next to one another for decoupling of overlapping, adjacent individual antennas is described in U.S. Pat. No. 4,825,162. The overlapping reduces the mutual inductance of the adjacent individual antennas. This is the overlapping, however, requires an intersecting guidance of the antenna conductors with corresponding intersection points. The antenna conductors must be directed insulated from one another at the intersection points. Capacitive couplings additionally occur at higher frequencies due to the capacitances formed at the intersection points.

### SUMMARY OF THE INVENTION

An object of the present invention is to provide an antenna array that is simplified in terms of its manufacture and that additionally exhibits no capacitive couplings at higher frequencies due to intersecting conductors. The array should additionally exhibit a good common mode signal suppression.

The object is achieved by an antenna array with multiple individual antennas arranged next to one another wherein, in accordance with the invention, the individual antennas are arranged within a radio-frequency, closed conductor loop and insert first capacitors into the conductor loops. Radio-frequency currents in the individual antennas induce voltages in the conductor loops and therefore also currents in the opposite direction dependent on the conductor loop resistance. These induced currents outwardly compensate the antenna currents, so the individual antennas are respectively inductively decoupled from one another. One advantage of this decoupling structure is that the conductors of the individual antennas have no intersection with each other. The decoupling structure therefore prevents capacitive couplings at higher frequencies as are present in the decoupling structure according to U.S. Pat. No. 4,825,162 (already cited above), for example. The intersection-free direction of the conductor loops also simplifies the mechanical design of the antenna array since neither the individual antennas nor the conductor loops must be directed in multiple overlapping layers. The current distribution to the conductor loops and therefore the decoupling effect can be adjusted with the inserted capacitors.

In an embodiment, the conductor loops are electrically connected with one another. The design of the decoupling structure is therefore further simplified.

A particularly advantageous embodiment results when the conductor loops and the individual antennas are respectively fashioned in the form of a regular hexagon. An optimal utilization of the available area therefore results for the individual antennas and the conductor loops.

The distance of the individual antennas from the conductor loops can therefore also be executed the same, whereby the decoupling acts uniformly for all individual antennas.

### BRIEF DESCRIPTION OF THE DRAWINGS

The single FIGURE shows an exemplary embodiment of the invention.

### DESCRIPTION OF THE PREFERRED EMBODIMENTS

The FIGURE schematically shows, in plan view, a section of an antenna array that is fashioned to acquire magnetic resonance signals for medical diagnostics. Magnetic resonance frequencies from approximately 10 MHz at 0.25 T up to approximately 120 MHz at 3 T basic field magnet strength result dependent on the basic magnetic field of the magnetic resonance apparatus. Even higher magnetic field strengths and therefore higher frequencies can also be used.

Individual antennas 2 that are arranged regularly on a carrier structure are provided to acquire the magnetic resonance signals. The carrier structure itself is not shown. For clarity only seven individual antennas 2 are depicted in the FIGURE. These individual antennas 2 represent a section from an (in total) 32-channel antenna array which should be symbolized by a dash-dot line 4 as a breaking edge. The 32 individual antennas 2 are arranged on a helmet-like structure for a head antenna array.

Each individual antenna 2 has conductors that are arranged in the shape of a regular hexagon on the carrier structure. Capacitors 6 are inserted into the center of each side of the hexagon. The individual antennas 2 are resonantly tuned to the operating frequency of the magnetic resonance apparatus (for example 126 MHz given a 3 T apparatus) by the capacitors 6. A signal connection to tap the acquired magnetic resonance signal is provided at one of the capacitors 6 at each individual antenna 2.

To decouple the individual antennas 2 from one another, each individual antenna 2 is respectively arranged within a radio-frequency, closed conductor loop 10. The conductors of the conductor loop 10 are likewise directed in the form of a regular hexagon like those of the individual antennas 2. The conductor loops 10 are all electrically connected with one another. The conductor sections of the conductor loops 10 that are directed between two individual antennas 2 are in particular connected with one another to form a single common conductor section. Such a conductor section is labeled with the reference character 12, for example.

A capacitor 14 is inserted into each side of the conductor loop 10 executed as a regular hexagon. The decoupling current in the conductor loops is adjusted with the capacitors 14. The adjustment ensues such that the decoupling current on the one hand flows counter to the antenna current in the corresponding individual antenna 2 and on the other hand is distinctly less than the actual induced antenna current in individual antennas 2 (for example 1/10 of the induced antenna current). This dimensioning provides a good compromise between the outward decoupling effect of the conductor loops 10 and the therefore simultaneous, unavoidable effective reduction of the actual antenna current in the individual antennas 2 that is effective for imaging. With the amplitude ratio of 1:10 it is also ensured that overall the voltage induced in a directly adjacent individual antenna is minimal. The conductor loops 10 as well as the total decoupling structure formed with them is thus also sufficiently non-resonant for the operating frequency of the magnetic resonance apparatus, such that said total decoupling structure does not have to be detuned during the transmission phase of the transmitter antenna (not shown).

Fewer limitations with regard to the dimensioning of the capacitors 14 in the conductor loops 10 are present when a detuning circuit (not shown here) is connected with the conductor loops, which detuning circuit detunes the entire decoupling structure formed by the conductor loops 10 in the transmission case. However, these variants require a higher structural element and circuit expenditure.

In the present exemplary embodiment the capacitors 14 of the conductor loops 10 and the capacitors 6 of the individual antennas 2 are arranged opposite one another, but this arrangement is not mandatory. Other limiting conditions, mechanical or electrical, can make a different embodiment more advantageous.

Although modifications and changes may be suggested by those skilled in the art, it is the intention of the inventor to embody within the patent warranted hereon all changes and modifications as reasonably and properly come within the scope of his contribution to the art.

I claim as my invention:

1. An antenna array comprising multiple individual antennas arranged next to one another, each antenna being arranged within a radio-frequency, closed conductor loop, with capacitors inserted into each conductor loops.

2. An antenna array according to claim 1, wherein the conductor loops are electrically connected with one another.

3. An antenna array according to claim 1, wherein the individual antennas and the conductor loops are arranged on a surface.

4. An antenna array according to claim 1, wherein each conductor loop circumscribes a regular hexagon.

5. An antenna array according to claim 1, wherein each individual antenna) circumscribes a regular hexagon.

6. An antenna array according to claim 1, wherein said capacitors are first capacitors, and comprising second capacitors inserted into the conductors of the individual antennas.

7. An antenna array according to claim 6, wherein the first and second capacitors are arranged opposite one another.

8. An antenna array according to claim 1, wherein the conductor loops and the individual antennas are identically designed.

9. An antenna array according to claim 1, wherein each individual antenna has a signal connection.
